(19) United States
(12) Patent Application Publication
(10) Pub. No.: US 2005/0117712 A1
(43) Pub. Date: Jun. 2, 2005

(54) Integrated system for monitoring telephone calls via computer keyboard having coupled audio output and modified keyboard

(76) Inventor: Jose Aparecido De Sousa, Sao Paulo (BR)

Correspondence Address: WILLIAM COLLARD;COLLARD & ROE, P.C., 1077 NORTHERN BOULEVARD, ROSLYN, NY, 11576, US

(21) Appl. No.: 10/959,865

(22) Filed: Oct. 6, 2004

(30) Foreign Application Priority Data
Nov. 29, 2003 (BR) 005941
Mar. 16, 2004 (BR) 001238

(51) Int. Cl. H04M 1/24

(52) U.S. Cl. 379/32.01

(57) ABSTRACT

“INTEGRATED SYSTEM FOR MONITORING TELEPHONE CALLS VIA COMPUTER KEYBOARD HAVING COUPLED AUDIO OUTPUT AND MODIFIED KEYBOARD”, consists of a microprocessor hardware (1) (managing board) installed into the serial board (2) of mother board (3) of CPU (4) from where they are interconnected with the monitor (6) and hence to the board (P) for answering/calling coupled to the keyboard (11) of the computer. On said keyboard (11), the transmission of voice reception is made by means of earphone with microphone (12), dialing being made from such keyboard (11). In this construction, keyboard (11) will be connected to the telephone line through cable (8) while the switch (15) functions and telephone hook. The integrated system includes a modified keyboard (11) that can be supplied together with the integrated system or separately, said computer keyboard (11) receives the board (P) for answering/calling. The system basically includes two options of use, in a first option of use of keyboard (11) the telephone (T) having earphone (12) and board (P) for answering/calling is interconnected with the managing board (1) comprised of a microprocessor hardware, and said managing board is coupled by means of data transmission cable (21) to the slot (22) of mother board (3) and this one is connected to the monitor (6) and also receives the keyboard cable (23). In the second option, keyboard (11) is directly connected to the telephone line through telephone (T) and managing board (1). the system includes an audio output (S).

### BRIEF SUMMARY

This specification refers to an Invention Patent Application of an innovative “INTEGRATED SYSTEM FOR MONITORING TELEPHONE CALLS VIA COMPUTER KEYBOARD HAVING COUPLED AUDIO OUTPUT AND MODIFIED KEYBOARD”, basically designed to monitor via computer telephone calls received and made, including important monitoring parameters further to allowing the user to work with the computer while speaking on the phone, and said system is based on a technology having its own software and hardware. In order to operate fully and with high efficiency, the system incorporates to the original keyboard an electronic component in the fashion of a printed circuit (answering/calling circuit) that actuates to receive and make telephone calls such as to allow said keyboard to operate integrated with the system, that is, interconnected to an information managing board or, optionally, simply as a telephone, and in both cases the telephone line is captured from the actuation of a specific screen eliminating the need for use of a conventional telephone set.

### STATE-OF-THE-ART

In the State-of-the-Art, a system is known for monitoring telephone calls always requiring that the calls be made on switched fixed telephone sets. In fact, this monitoring is not very efficient, since it does not fully integrate all the components, such as microcomputer integrated to the monitor, mouse, computer keyboard with telephone and printer. Furthermore, the State-of-the-Art does not contemplate the management determined by software and a microprocessor with “artificial intelligence” defined in technical terms.

In view of that, the State-of-the-Art monitoring system is basically based on a computer having a call identifier connected to a detection system supplied by the local telephone company to reveal as a differential only the exhibition of numbers recorded in a local list. This list only permits the search with name initials rendering difficult to find the desired person.

In summary, the State-of-the-Art monitoring system in practice is a call identifier coupled to a computer associating a list where the search for names still faces some difficulty.

### THE INVENTION'S MONITORING SYSTEM

In this Invention Patent application, a monitoring system accompanied of extraordinary resources was idealized, first because the system is built from a microcomputer integrated to monitor, mouse, computer keyboard with telephone and printer so that the whole system is controlled by specific software and a microprocessor having “artificial intelligence”. On the other hand, the monitoring system in reference allows the visualization of the complete record of the person on the other side of the line before the user answers the call, providing such data as name, address, telephone number and other.

More precisely, the monitoring system in reference has the characteristic of being perfectly suitable to the modem standards of computers and telephony besides coupling directly to the computer keyboard a board for answering/calling, and this keyboard in two different options may be interconnected or not to an information managing board. Technically, in case of being connected to such managing board, the system operates in full fashion associating software that allows the recording of additional information relating to the speaker of a received call. In case of not being connected to this managing board, the keyboard may act simply as a telephone with caller identification.

A further, important aspect of the present invention is the fact that the keyboard with the board for answering/calling may be marketed separately from the system, that is, when said board is coupled to the conventional keyboard, this may be marketed as a simple telephone, which is a revolutionary point in the invention context.

In another option, in case the user purchasing the keyboard with the board for answering/calling has the system incorporated into the computer, this separately purchased keyboard will become a telephone with the additional functions offered by the managing board.

The system originating this Patent application also stands out as a system that receives an audio output coupled to the telephone system integrated to the computer keyboard capable of actuating in manual and automatic modes aiming to receive the analog signal of the telephone, forwarding it to the sound board, transforming it into digital files and storing it in computer memory. With the aid of dedicated software, there will be management of voice files, that is, the database can then be accessed and handled.

In manual mode, the recording will be made through direct command of the user allowing the user to choose the content to be recorded.

In automatic mode, every time the “line” key is actuated the automatic recording of the records in the database will be made.

### DESCRIPTION OF DRAWINGS

The invention will now be described based on the attached drawings according to the following list:

FIG. 1 schematically represents the connections of the equipment set comprising the telephone call monitoring system with telephone integrated to computer keyboard and audio output.

FIG. 2 represents the lower portion of the keyboard with the input and output points to the telephone.

FIG. 3 represents the keyboard when viewed from the back indicating the telephone commands.

FIG. 4 represents the inside of the keyboard where it is located the circuit board for answering/calling.

FIG. 5 schematically represents the system including keyboard/telephone, the managing board, CPU with motherboard and monitor.

FIG. 6 represents the keyboard/telephone with board for answering/calling incorporated and connected to the managing board. The latter's function is to receive information in “assembler” language and send it to the motherboard. Commands and accesses are processed by the software in order to generate a database.

FIG. 7 electronically represents the board for answering/calling with the audio output.

FIG. 8 schematically represents the hardware employed in managing board performing micro processing of information.

FIG. 9 physically represents the managing board showing the telephone line entrance as well as the connection from keyboard/telephone.

FIG. 10 represents the hardware with emphasis to the communication ports.

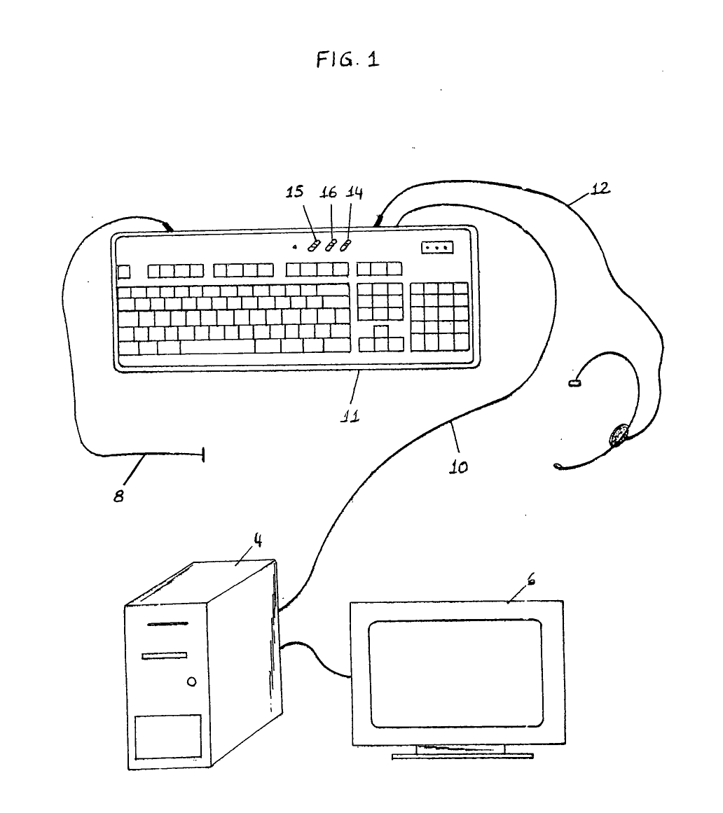

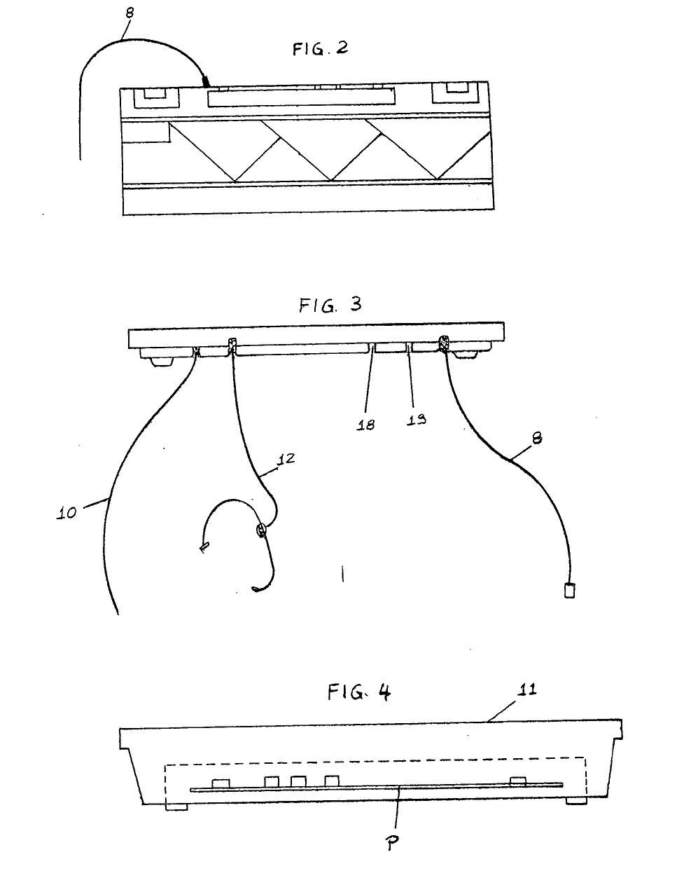

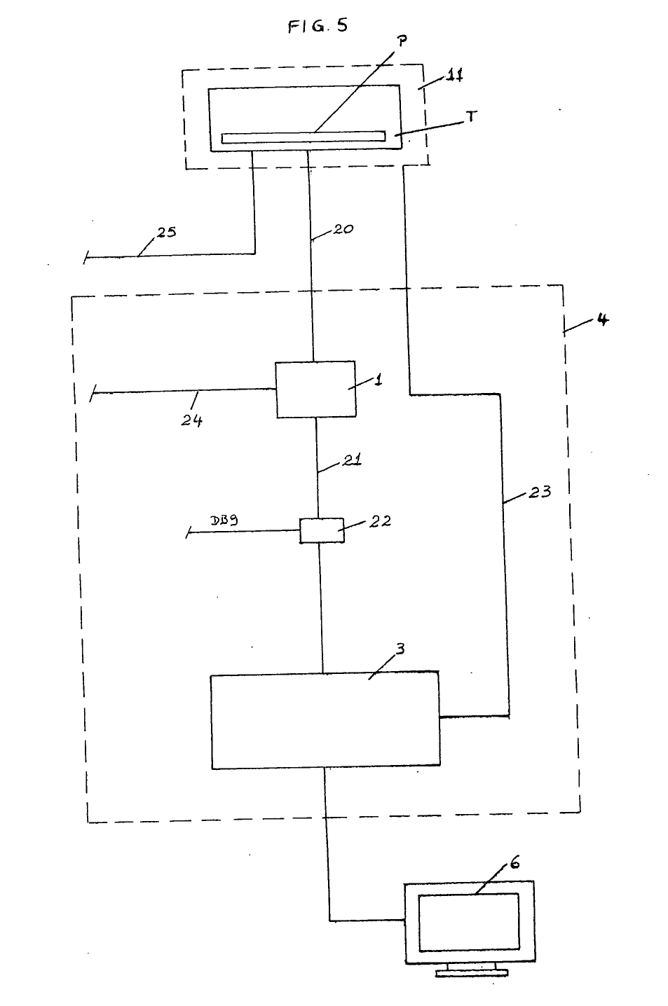

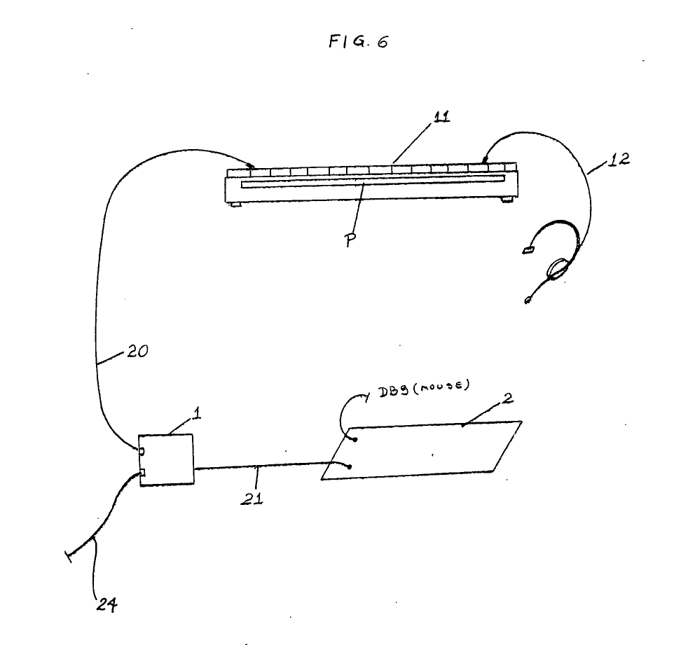

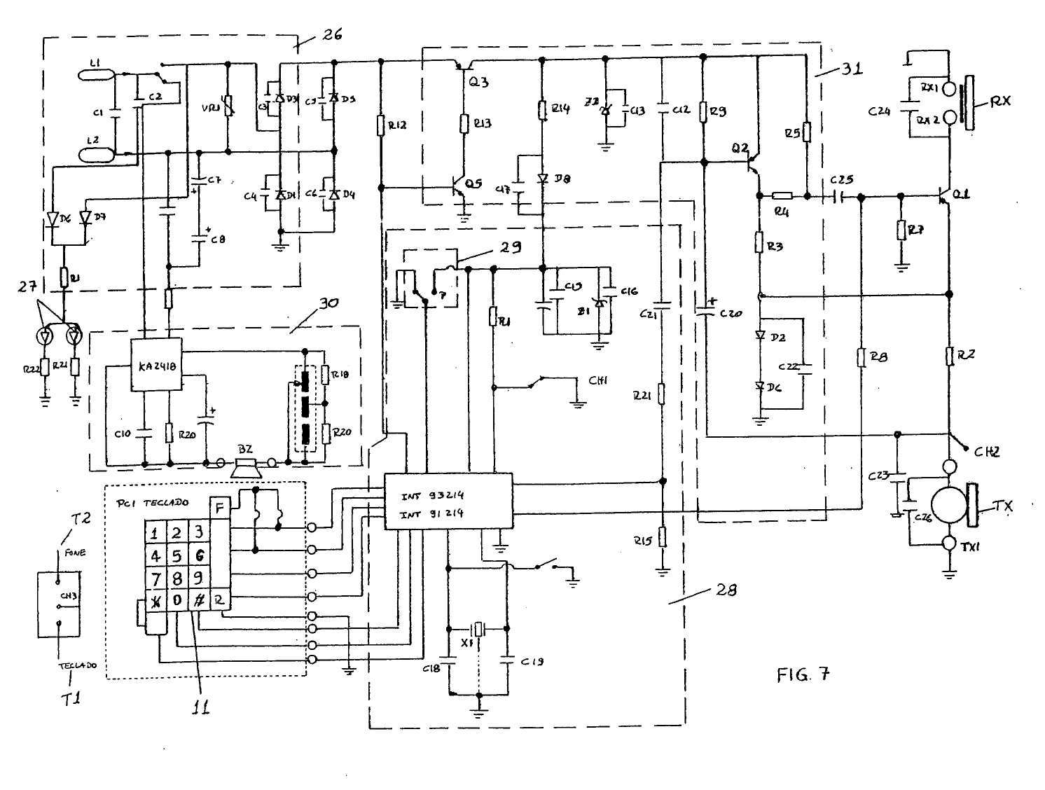

### DETAILED DESCRIPTION

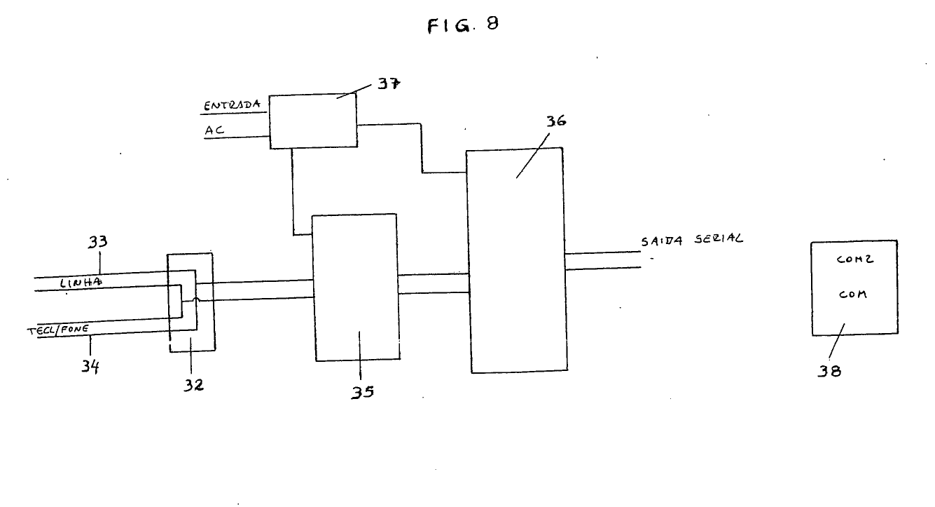

The “INTEGRATED SYSTEM FOR MONITORING TELEPHONE CALLS VIA COMPUTER KEYBOARD HAVING COUPLED AUDIO OUTPUT AND MODIFIED KEYBOARD” object of this Invention Patent application, consists of a microprocessor hardware (1) (managing board) whose logic employed is defined in FIG. 8, and this microprocessor is installed into the serial board (2) of motherboard (3) of CPU (4) where they are connected to the monitor (6) and from there to the board (P) for answering/calling coupled to keyboard (11) of the computer, and this telephone may be landline telephone or wireless telephone. In said keyboard (11) the transmission of voice reception by means of earphone with microphone is made (12), and the dialing is made from keyboard (11) of the computer while the selection mode between the use as a keyboard and as a telephone is inherent to switch (14). In this construction, keyboard (11) is connected to telephone line through cable (8) whereas switch (15) functions as telephone hook. Switch (16) is used to cut the voice transmission and subsequently said keyboard (11) with telephone is interconnected to CPU (4) by means of data transmission cable (10).

In the attached FIG. 3, the computer keyboard (11) is represented from below showing the entry of telephone line (8) as well as the exit (15) employed for the earphone with microphone (12), the switch (18) to select the dialing mode (tone or pulse), whereas switch (19) is employed to control buzzer and cable (10) is used for data transmission.

The computer keyboard (11) receives the board (P) for answering/calling, which is electronically defined in FIG. 7 to be described later.

According to the schematic diagram of FIG. 5, there is a first option of use of keyboard (11) including telephone (T) with earphone (12), whose board (P) for answering/calling of said telephone (T) is interconnected to managing board (1) composed of a microprocessor hardware, this interconnection is promoted by means of a normal cable line (20) (connector type RJ-11) and said managing board (1) is coupled by means of data transmission cable (21) (flat cable) to slot (22) of motherboard (3), and this connection may be made onboard or off-board, said slot (22) with mouse connection preferably DB9 type. The motherboard (3) is connected to monitor (6) and receives the keyboard cable (23). In this first option, the managing board (1) is connected to telephone line through conventional means (24).

In second option, according to FIG. 5, the keyboard (11) by means of telephone (T) and managing board thereof (1) is connected directly to the telephone line through conventional means (25) allowing in this version the use of keyboard (11) with conjugated telephone (T) only as a telephone.

As previously mentioned, such resources allow the keyboard (11) with telephone (T) to be marketed independently from the system, whether to operate only as a telephone or to work integrated to a computer already contemplating the system.

The board (P) for answering/calling, according to FIG. 7, shows a protection circuit (26) where the telephone line is seen through indications (L1/L2). The two-color LED (27) is also exhibited. This electronic scheme also shows the dialing circuit T ON-PULSE (28) in which the switch T ON-PULSE (29) is seen. The buzzer circuit (30) contemplates a buzzer volume switch, the transmission circuit (31) as well as the keyboard (11) in its electronic representation. This circuit also shows the transmitter (TX) and receiver (RX) as well as the switch (CH3) for inverting keyboard (T1) and telephone (T2).

The managing board (1) shows, according to FIG. 8 attached, hardware allowing not only its actuation as call identifier, but also performance of other monitoring functions to be further detailed, and this hardware includes a block (32) for entry of telephone line (33) in parallel with entry (34) from keyboard/telephone, a block (35) actuating as generator DT/MF decoder HT9170B with output for EPRON memory. Block (36) is the EPRON memory with serial output with assembler language MT 8870/AT 89C52. Block (37) is the power supply with AC input from microcomputer and DC 5V output counting with integrated circuit CI 7805. Block (38) is the microcomputer input in the slot of motherboard showing the communication port thereof.

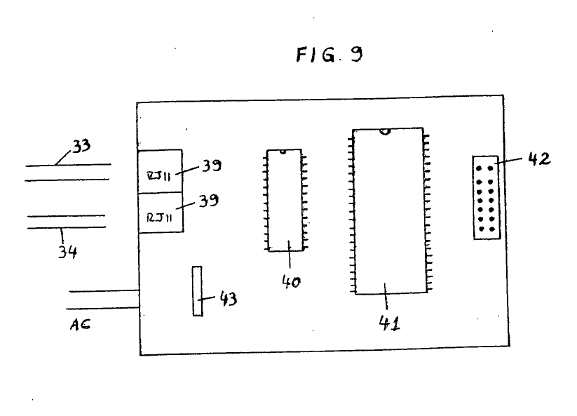

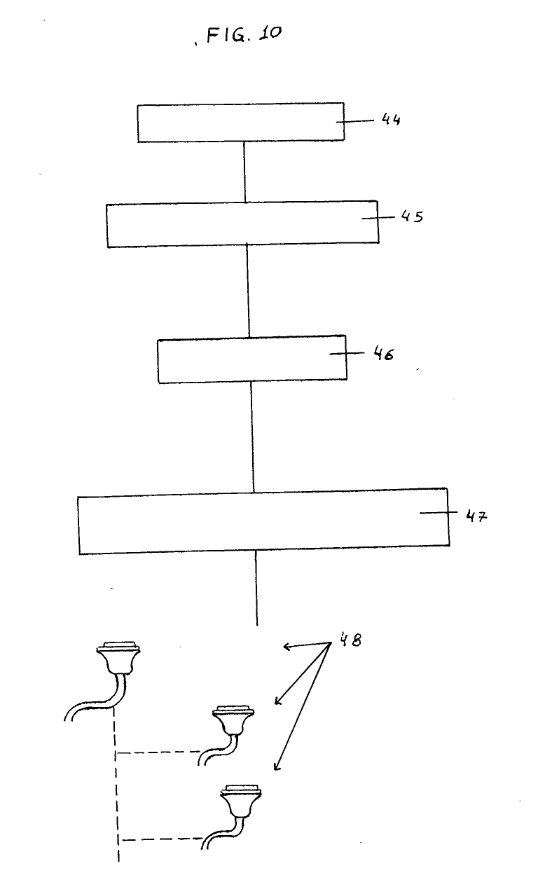

FIG. 9 shows the managing board (1) in a physical construction contemplating the standard connectors RJ-11 type (39) for input of telephone line or set allowing to visualize the inputs (33) and (34), and also shows the integrated circuit HT 9170BDT/MF (40) as well as the integrated circuit AT 89C52 or MT 8870 of EPRON memory with compatible output for microcomputer (41), the connector with output DB9 (42), and the integrated circuit CI 7805 (43) for power supply input.

FIG. 10 schematically represents the sequence in which the software conjugated with managing board (1) performs in the level of hardware comprised of the following menus: my computer (44), control panel (45), system (46), device manager (47) and next it is shown the ports (48) (COM and LPT) generating the communications port (COM2), communications port (COM3) from which arise the types of resources, that is, (COM2): input/output interval and stop request, (COM3): input/output interval.

FIG. 7 also shows the connection scheme of audio output to the system, and this audio output (S) is installed in reception (RX) of board (1), and this output is comprised of induction coils for filtering (L3/L4) as well as capacitors (C27/C28) for purposes of filtering audio in view of the need for filtering the signal for perfect recording.

The audio output (S) is interconnected to the soundboard (P1) installed in the computer CPU, and said audio output (S) is connected in parallel with the earphone of microphone (12). The audio output captures the analog signal of telephone and as it is connected to the microphone input of sound board (P1) installed in computer CPU this sound board (P1) promotes the transformation of the signal into digital files, storing them in the computer memory. This is done with the help of dedicated software (S1) by means of which the management of voice files is made, rendering possible for the user to access this database and consequently handle it this software is conventional.

Once the software and hardware are installed in the computer that will operate the integrated system, the icon referring to the system in reference will appear in the work area, and the LED (27) present in keyboard (11) will be blinking at this moment. The data transmission cable (10) connects the keyboard (11) to computer. In case the computer does not receive the data, LED (27) will be blinking whereas once the data transmission is concluded LED (27) will remain continuously illuminated. For completing the data transmission, it is necessary to double click the icon referring to the integrated system (in the work area) when said LED (27) will stop blinking and then it will be possible to visualize and use the computer as a whole.

In order to configure the software line of the integrated system click on button “menu” and then click the button “port” at which time a list of “ports” will be opened. At this time, click the port where the integrated system is installed on this screen there is an icon comprised of a desk telephone with a question mark above, and upon configuring the telephone line in the integrated system the question mark disappears. Upon clicking the icon “telephone”, a screen is opened where the user can determine that the integrated circuit identifies a telephone line. In the identifier field, type the number [0] that is the identifying number of first line. The other lines will be 1, 2, 3 and so forth. In the activated field, click once to activate the line in the integrated system. In the field “line,” type the number of the line that will be monitored by the integrated system in the field “notify call answered or made,” the type of monitoring desired should be clicked. You can opt between “notify call answered or made” and both situations. After filling up these fields, the button “search” should be clicked, at which time the integrated system will immediately install the telephone line in its internal system, starting its monitoring process.

When double clicking the icon of the integrated system, a screen of the call identifier will be opened, which will indicate the line being used by the system as well as the last call, with its date, time and call length.

Complying with the previous procedures, when the integrated system receives a call a blinking icon will appear in the bottom of the computer screen in the shape of a “yellow telephone,” alerting to the existence of a call registered in the integrated system, which has not yet been visualized. In order to visualize this call, double click the telephone line selected, that is, the line being monitored. This operation will open the “screen of calls registered” by the integrated system, where all calls answered and made can be seen. The integrated system allows visualization of the registration card of each call, and for such it is enough to double click on the “telephone line” whose registration card you want to check. This operation offers the resource of visualizing the complete record of individuals or entities calling your telephone. Furthermore, the “registration screen” a field with “notes” is provided, similar to an agenda, where it is possible to type any information about the individual or entity registered.

The integrated system also allows calls to be naturally “erased” by clicking on the call to be erased in order to select it, and then by clicking the button “erase call”.

The integrated system allows the issue of a report if you follow this sequence:
double click on the icon of the integrated system;
one click on the menu;
one click in report with following options:
   specify the initial date;
   specify the final date;
   specify whether the report will be of received or made calls;
Click the button of the field “file.” this process will open a screen to save your report:

OPTION: the user may create a folder and name it with the name or date of the report. Field “save as type”: the file is Tx[x.TxT]. Put the name of file and click “save”. Once this is done, the report screen will appear with the address here this report was saved. Then click the button “OK” to generate the file to visualize this file double click “my documents” and click the folder where the report was created.

Evidently, as it is intrinsic to any computer system, the report may be printed, saved to a floppy disk, cd-rom, and the user may access this report whenever he/she wants.

1) “INTEGRATED SYSTEM FOR MONITORING TELEPHONE CALLS VIA COMPUTER KEYBOARD HAVING COUPLED AUDIO OUTPUT AND MODIFIED KEYBOARD”, CHARACTERIZED BY a hardware microprocessor (1) (managing board) capable of actuating as call identifier as well as registering system and agenda monitoring answered and made calls and also allowing the issue of printed or copied reports, said hardware microprocessor (1) (managing board) is installed to the serial board (2) of motherboard (3) of CPU (4) from where it is interconnected with monitor (6) and hence to the board (P) for answering/calling coupled to the keyboard (11) of the computer, this telephone being a cord telephone or a cordless telephone. In said keyboard (11), the transmission of voice reception is made by means of earphone with microphone (12), and the dialing is made by said keyboard (11) of computer whereas the selection mode between the use as a keyboard and as a telephone is through switch (14). The keyboard (11) will be connected to the telephone line through cable (8) while switch (15) functions as a telephone hook. The switch (16) is used to cut the voice transmission and said keyboard (11) with telephone is interconnected to the CPU (4) by means of data transmission cable (10). The integrated system includes a modified keyboard (11) that may be supplied together with the integrated system or separately. Said computer keyboard (11) receives a board (P) for answering/calling. The system basically includes two options of use, in a first option the telephone (T) with earphone (12) and board (P) for answering/calling is interconnected to managing board (1) comprised of hardware microprocessor, such interconnection is promoted by means or normal line cable (20) (connector RJ-11) and said managing board (1) is coupled, by means of data transmission cable (21) (flat cable) to slot (22) of motherboard (3) and this interconnection may be made on board or off-board, said slot (22) having connection for mouse, preferably of the type DB-9. The motherboard (3) is connected to monitor (6) and receives the keyboard cable (23) and in this first option, the managing board (1) is connected to the telephone line by conventional means (24). the system also includes an audio output (S) installed in the reception (RX) of board (1), and this output is comprised of induction coils for filtering (L3/L4) as well as capacitors (C27/C28) for purposes of filtering audio in view of the need to filter the signal for perfect recording.

2) “INTEGRATED SYSTEM FOR MONITORING TELEPHONE CALLS VIA COMPUTER KEYBOARD HAVING COUPLED AUDIO OUTPUT AND MODIFIED KEYBOARD”, CHARACTERIZED BY a second option of use in which the keyboard (11) through the telephone (T) and its managing board (1), is directly connected to the telephone line by conventional means (25) allowing in this variation the use of keyboard (11) with conjugated telephone (T) only as telephone.

3) “INTEGRATED SYSTEM FOR MONITORING TELEPHONE CALLS VIA COMPUTER KEYBOARD HAVING COUPLED AUDIO OUTPUT AND MODIFIED KEYBOARD”, CHARACTERIZED in that the board (P) for answering/calling shows a protection circuit (26) where the telephone line is seen through indications (L1/L2), and it also shows the two-color LED (27). It also includes a dialing circuit TONE-PULSE (28), to which the switch TONE-PULSE (29) is coupled. The buzzer circuit (30) contemplates a buzzer volume switch. It also includes the transmission circuit (31) as well as the keyboard (T1) in its electronic representation this circuit also shows the transmitter (TX) and receiver (RX) as well as switch (CH3) for inverting keyboard (TI) and telephone (T2).

4) “INTEGRATED SYSTEM FOR MONITORING TELEPHONE CALLS VIA COMPUTER KEYBOARD HAVING COUPLED AUDIO OUTPUT AND MODIFIED KEYBOARD”, according to claim 1, CHARACTERIZED in that the managing board (1) is provided with a hardware that allows not only its actuation as call identifier but also to perform other monitoring functions, and this hardware includes a block (32) for input of telephone line (33) in parallel with input (34) from keyboard/telephone. A block (35) actuates as generator DT/decoder MF HT 9170B with output to EPRON memory. The block (36) is the EPRON memory with serial output in assembler language MT 8870/AT 89C52. The block (37) is the power supply with AC input from microcomputer and DC 5V output counting with integrated circuit CI 7805. The block (38) is the microcomputer input in the slot of motherboard with communication ports thereof. Physically the managing board (1) contemplates the standard connectors RJ-11 type (39) for input of telephone line or set allowing to visualize the inputs (33) and (34). It also shows the integrated circuit HT 9170B DT/MF (40), the integrated circuit AT 89C52 or MT 8870 of EPRON memory, with compatible output for microcomputer (41), the connector with output DB9 (42), and the integrated circuit CI 7805 (43) for power supply input.

5) “INTEGRATED SYSTEM FOR MONITORING TELEPHONE CALLS VIA COMPUTER KEYBOARD HAVING COUPLED AUDIO OUTPUT AND MODIFIED KEYBOARD”, according to claims 1 and 4, CHARACTERIZED in that the managing board (1) is comprised of a software determining in the level of hardware the following menus: my computer (44), control panel (45), system (46), device manager (47), ports (48) (COM and LPT) generating the communications ports (COM2) and (COM3) from which arise the types of resources, that is, (COM2): input/output interval and stop request, (COM3): input/output interval.

6) “INTEGRATED SYSTEM FOR MONITORING TELEPHONE CALLS VIA COMPUTER KEYBOARD HAVING COUPLED AUDIO OUTPUT AND MODIFIED KEYBOARD”, according to claims 1 or 5, CHARACTERIZED in that once the software and hardware are installed in the computer that will operate the integrated system, the icon referring to the system in reference will appear in the work area, and the LED (27) present in keyboard (11) will be blinking at this moment, whereas the data transmission cable (10) connects the keyboard (11) to computer. In case the data is not received by the computer, LED (27) will be blinking, whereas once the data transmission is concluded LED (27) will remain continuously illuminated. For completing the data transmission, it is necessary to double click the icon referring to the integrated system when said LED (27) will stop blinking and then it will be possible to visualize and use the computer as a whole. In order to configure the software line of the integrated system click on button “menu.” then click the button “port,” at which occasion a list of ports will be opened. At this time, click the port where the integrated system is installed. In this screen, there is an icon comprised of a desk telephone with a question mark above, and upon the setup of the telephone line in the integrated system, the question mark disappears. Upon clicking the icon “telephone,” a screen is opened where the user can determine that the integrated circuit identifies a telephone line. In the identifier field, type the number [0] that is the identifying number of first line, while the other lines will be 1, 2, 3 . . .

7) “INTEGRATED SYSTEM FOR MONITORING TELEPHONE CALLS VIA COMPUTER KEYBOARD HAVING COUPLED AUDIO OUTPUT AND MODIFIED KEYBOARD”, according to claim 6, CHARACTERIZED in that in the activated field click once to activate the line in the integrated system. In the field “line,” type the number of the line that will be monitored by the integrated system. In the fields “notify call answered or made,” the type of monitoring desired should be clicked. You can opt between “notify call answered or made” and both situations. After filling up these fields, the button “search” should be clicked, at which time the integrated system will immediately install the telephone line in its internal system, starting its monitoring process. When double clicking the icon of the integrated system, a screen will be opened for the call identifier, which will indicate the line being used by the system as well as the last call's date, time and length. When the integrated system receives a call, a blinking icon will appear in the bottom of the computer screen in the shape of a “yellow telephone,” alerting to the existence of a call registered in the integrated system and that has not yet been visualized. In order to visualize this call, double click the telephone line selected, that is, the line being monitored, and this operation will open the “screen of calls registered” by the integrated system, where all calls answered and made can be seen. The integrated system allows visualization of registration card of each call, and for such it is enough to double click on the “telephone line” whose registration card you would like to check. This operation offers the resource of visualizing the complete record of individuals or entities calling your telephone. It also provides in the “registration screen” a field with “notes,” similar to an agenda, where it is possible to type any information about the individual or entity registered. The integrated system also allows the calls to be naturally “cleared.” This is obtained by clicking on the call to be cleared in order to select it and then clicking the button “clear call”.

8) “INTEGRATED SYSTEM FOR MONITORING TELEPHONE CALLS VIA COMPUTER KEYBOARD HAVING COUPLED AUDIO OUTPUT AND MODIFIED KEYBOARD”, according to claim 6 or 7, CHARACTERIZED in that the integrated system allows the issue of a report according to the following sequence:
to promote a double click on the icon of the integrated system;
one click on the menu;
one click in report with following options:
to specify the initial date;
to specify the final date;
to specify whether the report will be of received or made calls;
click the button of the field “file.” this process will open a screen to save your report:
OPTION: it is possible to create a folder and name it with the name or date of the report. Field “save with type”: the file is Tx[x.TxT]. Put the file name and click “save.” Once this is done, the report screen will appear with the address where this report was saved. Then click the button “OK” to generate the file to visualize this file, double click “my documents” and click the folder where the report was created.

9) “INTEGRATED SYSTEM FOR MONITORING TELEPHONE CALLS VIA COMPUTER KEYBOARD HAVING COUPLED AUDIO OUTPUT AND MODIFIED KEYBOARD”, according to claim 1, CHARACTERIZED in that the audio output (S) is interconnected to the sound board (P1) installed in CPU of computer, and said audio output (S) is connected in parallel with the earphone of microphone (12). the audio output captures the analog signal of telephone and as it is connected to the microphone input of sound board (P1) installed in CPU of computer this sound board (P1) promotes the transformation of this signal into digital files storing them in the computer memory. This is done with the help of dedicated software (S1) by means of which it is made the management of voice files rendering it possible for the user to access this database and as a consequence the handling thereof.

10) “MODIFIED KEYBOARD”, according to claims 1 and 2, CHARACTERIZED in that the keyboard (11) having board (P) for answering/calling is supplied together with the integrated system to operate together with the software and hardware of managing board (1).

11) “MODIFIED KEYBOARD”, according to claims 1, 2 or 9, CHARACTERIZED in that keyboard (11) with board (P) for answering/calling is supplied separately from the system, in this case actuating only as telephone, or ready to be applied to a computer having the integrated system incorporated.

12) “MODIFIED KEYBOARD”, according to claims 1, 2, 9 or 10, CHARACTERIZED in that the computer keyboard (11) contains the input for telephone line (8) as well as output (15) employed for earphone with microphone (12), the switch (18) for selecting the dialing mode (tone or pulse), whereas switch (19) is employed to control buzzer and cable (10) is used for data transmission.
